(19) United States
(12) Patent Application Publication
(10) Pub. No.: US 2018/0115132 A1
(43) Pub. Date: Apr. 26, 2018

(54) Crimping Tool Locator, Crimping Tool Head, Crimping Tool and Method for Manufacturing a Crimping Tool Locator

(71) Applicant: WEZAG GmbH Werkzeugfabrik, Stadtallendorf (DE)

(72) Inventors: Thomas Glockseisen, Duesseldorf (DE); Kurt Battenfeld, Ebsdorfergrund/Wittelsberg (DE)

(21) Appl. No.: 15/727,719

(22) Filed: Oct. 9, 2017

(30) Foreign Application Priority Data
Oct. 24, 2016 (EP) 16 195 250.2

(51) Int. Cl. H01R 43/042; B25B 27/14

(52) U.S. Cl. CPC H01R 43/0428; B25B 27/146

(57) ABSTRACT

The invention relates to a crimping tool locator (1). The crimping tool locator comprises a component (3), in particular a base body (4), which is preferably manufactured from a transparent plastic material. Accommodations (5) of the base body (4) for a workpiece (6) are each equipped with a lining (41) which can e.g. be manufactured from a transparent plastic material or metal. Despite of the use of a material which in some cases comprises a reduced wear resistance or hardness by use of the lining (41) it is possible to provide a large lifetime of the crimping tool locator (1) and the accommodations (5). By use of a transparent plastic material for the base body (4) it is possible that the user of the crimping tool is able to inspect the accommodation (5) from the outside and to analyse if a workpiece (6) arranged in the accommodation (5) is in the correct position. Preferably, a lightening device (9) is integrated into the crimping tool locator (1). The lightening device (9) illuminates the accommodation (5) through the transparent material.

### CROSS REFERENCE TO RELATED APPLICATIONS

This application claims priority to co-pending European Patent Application No. EP 16 195 250.2 filed Oct. 24, 2016.

### FIELD OF THE INVENTION

The invention relates to manually actuated crimping tools by which it is possible to create connections between electrical cables and plugs in a reliable process. In crimping tools of this type so-called crimping tool locators can be used. The crimping tool locators can form a permanent component of the crimping tool, can be optionally arranged at the crimping tool or might also be retrofitted to a present crimping tool.

A crimping tool locator serves for securing that the plug which is to be crimped to the cable is always arranged in the predefined relative position and orientation at the crimping tool head. By this measure it is provided that the plug is connected to the cable in a predetermined relative orientation and position. On the other hand the crimping tool locator provides that during the crimping process the plug is arranged and held in the predefined orientation and position relative to the tools of the crimping tool, in particular dies so that the crimping process is performed in the predetermined regions of the plug, in particular in the region of the so-called cable crimp or insulation crimp. Additionally, in some cases the crimping tool locator also guarantees that the cable is inserted with the predefined insertion depth into the plug. Preferably, the crimping tool locator is also adapted to the tool head or pliers head such that during the crimping process a rotation of the plug is impeded which in particular serves for avoiding an asymmetrical curling. Within the framework of the invention the crimping tool locator is e.g. used for a manually actuated crimping tool as for example crimping pliers. However, it is also possible that the invention is used for a crimping tool which is driven hydraulically, pneumatically or electrically or for a (partial automized or completely automized) crimping machine.

### BACKGROUND OF THE INVENTION

The publication US 2011/0235312 A1 discloses crimping pliers. The pliers head of the crimping pliers comprises a frame. A lightening device is fixed at the frame. The lightening device in a focussed way illuminates a crimping region of the pliers head wherein the plug is crimped. For this purpose the lightening device is arranged in the close neighbourhood of the crimping region. It is also suggested to arrange a lightening device at a frame of a crimping tool which is hydraulically or pneumatically driven. The frame to which the lightening device is mounted serves for guiding a moveable pliers jaw as well as for supporting a fixed pliers jaw. The pliers jaws each support crimping dies which deform the plug which is to be crimped. The lightening device can be mounted in a removable way at the frame so that also an exchange or an adaptation of the lightening device is possible. The assembly of the lightening device to the pliers head can be performed without any tool. It is also possible that the lightening device is mounted to a crimping pliers locator, the crimping dies or the actuating device of the crimping pliers. The lightening device comprises a housing. The housing supports a power source, a lamp and a switch. In an end the housing comprises a mounting region serving for mounting the housing to the pliers head. For one embodiment the housing is formed by two parts with a base element and a lid. In this case the power source, the lamp and the switch can be assembled to the base element and can then be covered by the lid. The lamp is arranged in an opening of the housing. In the region of the opening the housing forms a kind of shield by which it is possible to define the orientation of the emitted light. Optionally, in the region of the opening for the lamp also a lens can be arranged for focusing the emitted light and/or for defining the orientation of the light. The shield might have a reflecting surface. The lamp is e.g. a LED. The power source can be one battery or a plurality of batteries. The switch of the lightening device comprises two states “on” and “off”. A switching element of the switch protrudes from a switching slot of the housing so that it is possible to manually actuate the switching element from the position “on” into the position “off” (and vice versa). A fixation of the lightening device can be provided by fixing elements, magnets, a glue, a threaded connection or welding. It is also proposed to arrange the components of the lightening device at positions distributed over the crimping pliers. Here it is possible that a battery is arranged in the region of a hand lever. The battery is then connected by a cable extending along the longitudinal axis of the crimping pliers to a LED. The LED is held at side struts of the O-shaped frame and illuminates the crimping region from the side. In this case it is also possible that the switch is arranged in the region of the hand lever. Furthermore, the document proposes that the switching element is actuated automatically when actuating the hand levers: In the completely opened state of the hand levers the switch is in the position “off”. If instead the hand levers are moved towards each other, the switch is automatically closed so that the position “off” is achieved. For the case that the lightening device is arranged in the crimping tool locator US 2011/0235312 A1 proposes that the crimping pliers locator comprises a base body. The base body is manufactured from a transparent, semi-transparent or translucent material so that it is possible that light emitted from the lamp is sent (after passing through the base body) towards the crimping region.

JP H02 25189 U discloses a crimping tool locator for crimping pliers. The crimping tool locator comprises an L-shaped supporting plate. It is possible to mount the crimping tool locator with a leg of the L of the supporting plate to a pliers jaw of the crimping pliers. The other leg of the L of the supporting plate comprises a step in the end region facing away from the crimping pliers. A lid plate having an orientation parallel to this leg of the L of the supporting plate is screwed to the step. Correlating to the dimension of the step there is an intermediate space between the leg of the L of the supporting plate and the lid plate. The intermediate space is open towards the crimping pliers as well as in lateral direction. It is possible to insert a plug into the laterally open intermediate space from the side of the crimping pliers. Here, the plug is an eye-shaped flat plug. The thickness of the metal sheet of the flat plug is slightly larger than the height of the intermediate space. A front side of the lid plate facing towards the crimping pliers forms a stop for the cable core of the cable which is introduced into clamping jaws of the plug. The front face of the lid plate might comprise recesses being semi-open in the cross section and allowing the entry of the cable core of the cable until the front face of the cable core of the cable contacts the bottom of the recess. Accordingly, an accommodation of the crimping tool locator for the cable core of the cable is solely limited by the recess of the lid plate whereas the accommodation for the plug is formed on both sides by two separate components screwed to each other, namely the supporting plate on the one hand and the lid plate on the other hand. It is proposed that the lid plate is manufactured from a transparent material.

### SUMMARY OF THE INVENTION

The invention proposes a crimping tool locator which can be connected (e.g. by a connecting region; fixedly, in a moveable fashion or in a rotatable fashion) to a crimping tool. Within the framework of the invention the crimping tool locator comprises at least one accommodation for a plug. Preferably a plurality of accommodations of this type is provided which can be designated for plugs being of the same or different types and having the same or different geometries. Common accommodations of a crimping tool locator for a plug are formed by recesses of a component, in particular a base body. The physical properties of the accommodations (in particular the wear resistance of the accommodations) is determined by the material of the component which limits or defines the accommodations.

The invention proposes that the accommodation is not only limited by the material of the component, in particular the base body. Instead, the limitation of the accommodation is provided (at least) in a first part of the circumference by the material of the component or base body whereas the limitation of the accommodation in (at least) one other part of the circumference (here also named a second part of the circumference) is provided by a lining of the component. Here, the material of the lining preferably comprises a hardness being higher than the hardness of the material of the component or the base body. Accordingly, the lining serves for the provision of an increased hardness and so of the wear resistance of the accommodation. By equipping the accommodation with a lining the requirements for the material of the component or base body are reduced because a support of the plug in the accommodation, a guidance of the plug when inserting or removing the plug into and from the accommodation and/or the holding of the plug in the accommodation is at least partially provided by the lining. Accordingly, by the invention it is possible to extend the possibly useable materials for the component or the base body.

With the novel crimping tool locator, it is possible to propose a crimping tool locator, a crimping tool head, a crimping tool and a method for manufacturing a crimping tool locator by which it is possible to provide an exact predetermined orientation and position of a workpiece (in particular a plug) at a crimping tool with an increased reliability.

The afore mentioned component comprising the lining might be any component of the crimping tool locator, e.g. a module (or module part), a covering plate or a base body. In the following partly reference is made to the component being a base body without a limitation of the invention to this embodiment being intended.

Another embodiment of the invention in the beginning bases on the finding that according to the publication US 2011/0235312 A1 the attention is turned to the task to illuminate the crimping region which is anyway visible in the crimping pliers. Accordingly, there is no new option created for optical observation. Instead, the additional illumination improves the optical resolution (e.g. of shadowed parts) in the viewing region anyway present at the crimping pliers (here the crimping region). However, it has shown that only a part of possible error sources for producing an improper crimp can be monitored in this way. Furthermore, when running through the crimping stroke and when then detecting an improper crimping of the plug to the cable in the crimping region there has already occurred (in a non-reversible fashion) a plastic deformation of the plug and the cable. This leads to the production of scrap which in particular causes problems if the cable had already been connected to other components (e.g. the cable is already a component of an installation system of a vehicle, an airplane or a building).

One embodiment of the invention bases on the finding that one source for a non-proper production of a crimping connection might be that the plug is inserted in a non-proper way into the crimping tool locator, in particular with an angular error of the longitudinal axes of an accommodation of the crimping tool locator on the one hand and the plug on the other hand and/or with the insertion of the plug and/or cable into the crimping tool with an insertion path being too short or too long. An error source of this type cannot be detected for common crimping tools. In particular an error source of this type is not necessarily detected in the crimping region and also not necessarily detected outside of the crimping tool locator even when using an illumination device according to US 2011/0235312 A1. Instead, according to the prior art the afore mentioned error source can only be avoided to a limited extent by an increase of the care exercised during the insertion of the plug into the accommodation of the crimping tool locator.

For this embodiment it is proposed that in the crimping tool locator the component is (at least partially) transparent. The transparent component defines or limits (partially in a part of the circumference) the accommodation for the plug. Furthermore, the component (at least partially) forms the outer surface of the crimping tool locator. The transparent material of the component extends between the accommodation and the outer surface with the consequence that the user of the crimping tool is able to look through the transparent material of the component and in this way the user gains insight into the accommodation. Accordingly, the user is able to
optically monitor the proper insertion of the plug into the accommodation,
optically inspect if the plug is in the correct position and orientation in the accommodation and/or perform a correction of the position and orientation of the plug in the accommodation under a simultaneous optical control.

In this way the precision of the positioning of the plug in the accommodation and so the precision of the positioning of the plug in the crimping region during the execution of the crimping process is increased. Optionally, it is also possible that the user optically monitors to what extent the cable extends through the plug.

Within the framework of the invention a “transparent” component is a component by which it is possible to optically capture from the outside at least outer contours of a plug arranged in the accommodation. It is also possible that the transparent component is only translucent, comprises a colouring and the like. However, it is also possible that the component is completely transparent corresponding to a non-coloured glass material. Here, the transparent component might be formed by a transparent solid material or e.g. by a composite body as long as there is a transparent part allowing an optical inspection of the accommodation for the plug.

Without the inventive lining the accommodation for the plug would only by limited by the transparent material. In this case only the transparent material would be responsible for providing the friction surface and/or guiding surface for holding, inserting and removing the plug from the accommodation of the crimping tool locator. In this case the transparent material would be biased by considerable mechanical biases. If there was wear of the transparent material in the region of the accommodation, an exact positioning of the plug in the region of the accommodation would no longer be possible. Accordingly, the crimping tool locator would no longer be able to fulfil its function so that an exchange would be required. By use of the inventive partial limitation of the accommodation by the lining it is possible to reduce the biases of the transparent material. By these measures in some cases for the first time the wear resistant use of a transparent material in the region of the accommodation becomes possible. Here, the lining might e.g. be manufactured from a transparent or non-transparent material (in particular a plastic material or metal). However, in the two afore mentioned cases the lining of the component is preferably manufactured from a material which is harder than the transparent material of the component. In some cases by way of the use of the lining of the component a reduction of the mechanical requirements for the material of the component can be achieved. Accordingly, e.g. a reduction of the material costs for the transparent component is possible or also materials can be used for the component which allow to look through with a higher extend than other transparent materials which can be biased with higher mechanical biases. On the other hand, the material for the transparent component can be purposefully adapted to other functions of this component. So, it is e.g. possible to purposefully use an elastically or plastically deformable material or to use a material which provides a good connection to adjacent components and the like, to mention only some examples which are not intended to limit the present invention.

According to another proposal of the invention the lining is not closed in circumferential direction in a way that the lining completely encloses the plug in the accommodation (which would have the result that for a non-transparent lining despite of the use of the transparent material for the component it is not possible to inspect the accommodation for the plug). Instead, for this proposal the lining forms a window. The window and the lining are designed and arranged such that it is possible to inspect the interior of the accommodation through the transparent component and the window. Accordingly, for this embodiment there is a functional separation on the one hand with the use of the lining made from a wear-resistant and/or hard material for providing in an enduring way a good positioning of the plug in the accommodation by exposing the lining at least partially with the mechanical biases of the accommodation during insertion into the accommodation, during the holding of the plug and during removal of the plug from the accommodation. On the other hand, the transparent material and the window of the lining can be used for still providing the option of an inspection of the accommodation for the plug.

For the design of geometry of the lining there are a lot of options. For one variant of the invention the lining is a sleeve with any cross sectional geometry which might be constant or might change over the longitudinal extension of the sleeve. In order to provide the option of an inspection of the accommodation for the plug despite of the use of a sleeve as the lining, the sleeve comprises (at least) one window arranged in a region of the circumferential surface. Furthermore, it is possible that the sleeve is open or closed in the end region facing away from the insertion opening. In the case that the sleeve has a closed design in this end region or comprises a web having an orientation transverse to the longitudinal axis of the accommodation, it is possible that the lining at the same time also serves as an end stop for inserting the plug and/or a cable into the accommodation. Generally, a sleeve of this type might provide a high mechanical resistance and a good guidance of the plug in the accommodation.

For one variant of the invention the lining comprises a web which extends in longitudinal direction of the accommodation. When inserting the plug into the accommodation, the plug is able to slide along the web under guidance by the same. For this embodiment the window is formed adjacent the web when seen in circumferential direction of the accommodation and limited by the web. In an extreme case it is possible that the web only comprises a very small circumferential extension. In this case the window extends over the entire remaining circumferential region of the accommodation. However, it is also possible that a plurality of webs of this type which extend in longitudinal direction of the accommodation are located at positions dispersed in circumferential direction. Accordingly, then there is plurality of windows arranged at positions also dispersed in circumferential direction. In this case it is possible that the webs are formed separately from each other or connected to each other.

It is possible that the lining and in particular the sleeve is rotationally symmetrical or not rotationally symmetrical with respect to the longitudinal axis of the accommodation. Furthermore, it is possible that the lining in a half longitudinal section or that at least one web has a straight design or is stepped in any way or otherwise curved wherein the chosen shape in particular correlates to a contour of a plug which is to be positioned therein and/or to a clamping or latching mechanism for the plug in the accommodation.

For a particular proposal of the invention the lining is U-shaped in a first approximation. In this case the lining comprises a base leg and two side legs. The two parallel side legs of the U (which might have the same or different longitudinal extensions) extend as webs in the longitudinal direction of the accommodation. Here, the two webs or side legs of the U are located at opposite positions in the accommodation when seen in circumferential direction. Instead, the base leg of the U is located in a bottom region of the accommodation. By the base leg on the one hand a good mechanical coupling of the two webs is provided. On the other hand, in some cases by means of the base leg of the U a wear resistant stop for the insertion of the plug and/or of the cable into the accommodation is provided.

For a further embodiment of the invention it is proposed that a lightening device is provided in the crimping tool locator. Here, the lightening device might e.g. comprise at least one lamp, cables, an energy source as a battery or an accumulator and/or a switch. Generally, the lightening device might similar to US 2011/023512 A1 serve for illuminating the crimping region. It is also possible that the lightening device serves for using the crimping tool (e.g. in dark rooms) as a kind of flashlight or pocket lamp. For this purpose it is e.g. possible that the lamp is located in the region of a tool head and illuminates the surrounding area in the direction of a longitudinal direction of the tool head or transverse to the same. For a particular proposal the lightening device is (also or solely) responsible for illuminating the interior of the accommodation and so a plug arranged in the accommodation. Here, it is possible that the lightening device and in particular the lamp of the lightening device is located at any position of the crimping tool locator. For another proposal of the invention the lightening device illuminates the interior of the accommodation through a window of the lining. The window might be the window which also provides the inspection of the accommodation by the user. However, it is also possible that the interior of the accommodation is inspected through one window whereas the illumination is provided through another window.

Generally it is possible that the lamp illuminates the interior of the accommodation through a bore or any other recess of the crimping tool locator. For one proposal according to the invention a lamp of the lightening device is covered by the component made of a transparent plastic material. In this way in particular contaminations of the lamp or even damages of the lamp can be avoided.

According to another proposal of the invention the lightening device comprises a lens by which it is possible to direct, focus and/or widen the cone of light of the lamp. For a particular embodiment of the invention the lamp is made from the transparent material of the component which in this case has a corresponding shape. Alternatively or cumulatively it is possible that the lightening device comprises a reflector in order to reflect the light of the lamp towards the interior of the accommodation and to improve the lightening efficiency and to create an accommodation illuminated as bright as possible with the use of an amount of energy being as small as possible. Alternatively or cumulatively it is possible that the reflector serves for avoiding an exit of light at other places which might e.g. dazzle the user.

Generally, it is possible that the crimping tool locator is manufactured with any components and shapes of the housing. For a particular proposal of the invention the crimping tool locator comprises at least one covering plate. The covering plate is made of a non-transparent material or preferably from a transparent material. In the latter case it is possible to inspect the interior of the accommodation through the covering plate. Here, it is possible that the covering plate is on the one hand suitable for providing an optically pleasing housing. It is also possible to choose a material for the covering plate which provides a resistant outer surface. The covering plate might also fulfil different other functions. It is e.g. possible that the inner side of the covering plate is reflective for providing a mirroring effect. Accordingly, the inner side of the covering plate provides a reflection and so an improved lightening efficiency. In the case that the covering plate is a covering plate made of metal, the covering plate might be polished and/or coated on the inner side for providing a reflection as described above. It is also possible that the covering plate provides a focusing of the reflection. In this case the reflector might e.g. have a concave shape for providing a focusing of the reflecting light towards the accommodation. If the cover plate is non-transparent, in this way an exit of light to the exterior (which might bother the user) can be avoided. Furthermore, it is possible that a multi-part housing of the crimping tool locator is formed with the cover plate. Here, another housing part forms an inner chamber wherein the lightening device or parts of the same are accommodated. The covering of the inner chamber is then provided with the assembly of the covering plate to the housing part which forms the inner chamber. If the component of the lightening device which is arranged in the inner chamber is a switch, it is possible that the covering plate comprises a recess. An actuation means of the switch extends through the recess so that it is possible to actuate the switch from the exterior through the covering plate.

It is generally possible that the illuminating characteristic of the lightening device is fixedly defined by the manufacturer. However, for one embodiment of the crimping tool locator it is possible to adjust the cone of light of the lightening device. Here, the adjustment might be an adaptation of the orientation of the lightening, a change of the focusing or widening and/or a change of the brightness of the cone of light.

It is possible that it might be required that in the crimping tool locator the component or other components require a suitable connection to a bearing sleeve, a threaded sleeve, a guidance, a cover or a functional element or a component of the lightening device which might be provided in any way within the framework of the invention. For a particular proposal of the invention the material of the transparent plastic of the component is moulded or injection moulded to the bearing sleeve, the threaded sleeve, the guidance, the cover, the functional element or the component of the lightening device or connected by casting with the same. It is e.g. possible that the threaded sleeve, the guidance, the cover or the functional element or component of the lightening device is first inserted into a cavity for the manufacturing of the component from a transparent plastic material. With the moulding or casting of the transparent plastic material into the cavity then simultaneously the connection to the bearing sleeve, the threaded sleeve, the guidance, the cover, the functional element or the component of the lightening device is established. In this way a simple but nevertheless very reliable connection is provided. On the other hand, it is possible that the transparent plastic material protects the bearing sleeve, a threaded sleeve, the guidance, the cover, the functional element or the component of the lightening device. In order to mention only one simple example, it is possible that a cable of the lightening device is integrally cast with the plastic material of the component. Accordingly, a cable break is avoided in a reliably way and also another protection of the cable is provided. In particular for electric or electronic components an integral casting of this type with the transparent plastic material might also provide an electrical insulation and/or a sealing against humidity.

For the design and the integration of the lining into the crimping tool locator there are a lot of options. For one proposal of the invention the lining is an insert which is inserted into the component. Here, there are a lot of options. To mention only some non-limiting examples, it is possible that the component comprises a groove or recess into which then the lining (in particular a web of the same) can be inserted. Here, it is possible to fix the insert after its insertion in any way to the component. It is e.g. possible that the insert is latched or clamped with the component or held by press fit. It is also possible that in the component the insert is held by a common fixing element, in particular a securing ring, a screwed connection and the like.

For another variant of the invention the lining is connected by a material bond to the component. Here, it is e.g. possible that the lining is manufactured as a separate part and then connected to the component by an adhesive or a glue. It is also possible that the lining is integrally cast or injection moulded to the transparent material of the component or that the transparent material of the component is injection moulded to the lining.

For the materials on the one hand of the component and on the other hand of the lining and their geometries there are a lot of options. It is e.g. possible that the component is made of a transparent plastic material whereas the lining is made of a metal. For one proposal of the invention the component is made of a first plastic material which is transparent. The lining is then manufactured from a second plastic material which is not transparent. Here, the second material has a higher wear resistance and/or is harder than the first plastic material. In this way a lining is able to provide a high durability against mechanical biases.

For another proposal of the invention the lining (which in this case is manufactured from a transparent material) forms a kind optical wave guide. The optical wave guide extends between a lamp of the lightening device and a crimping region or the accommodation. In some cases the optical wave guide is in a direction transverse to the transfer direction delimited by the plug arranged in the accommodation and/or by the in this case non-transparent material of the component or base body. Accordingly, light of the lamp of the illuminating device is transmitted by means of the optical wave guide. Here, preferably there is a transmission towards the accommodation or to the outside of the crimping tool locator towards the crimping region. For this embodiment the transparent material of the lining might be harder or softer than the material of the component or base body.

Another solution of the object of the invention is given by a crimping tool head or crimping tool comprising a crimping tool locator as described above.

Another solution of the object of the invention is given by a method for manufacturing a crimping tool locator which is in particular a crimping tool locator as described above. In a method of this type in a first method step a base body is manufactured in an injection moulding process. Here, a first plastic material (in particular a transparent plastic material) is injected into a cavity. Here, the cavity, an insert and/or a core delimit already a part of the accommodation so that after the hardening of the first plastic material already a part of the contour of the accommodation is given. Furthermore, in particular by means of an insert or a core the cavity for the lining is delimited. In a subsequent second method step then a second, preferably non-transparent plastic material is injected into the cavity. The second plastic material is harder and more wear resistant than the first plastic material. The cavity into which during the second method step the material is injected is (in the region of the recess for the lining left empty during first method step) limited by the base body made of the first plastic material. Furthermore, the cavity is limited by an insert or a core. Here, the contour of the outer surface of the insert or the core is arranged and designed such that the accommodation is delimited both by the region delimited by the first plastic material as well as by the second plastic material injected into the cavity. Accordingly, after the hardening of the second plastic material the second plastic material injected into the cavity and the first plastic material complete to the accommodation. Here, the region of the accommodation produced during the first method step is limited by the first plastic material whereas in the region of the recess left free during the first method step the accommodation is delimited by the second plastic material. By the use of a method of this type it is possible to manufacture the transparent base body with the lining in a simple way with an injection moulding method comprising two steps by use of different inserts, cavities or cores. Here, at the same time a good connection between the lining and the material of the base body is established. It is possible that with a manufacturing method of this type directly the final surfaces of the accommodation are produced. However, also a partial or complete post processing (e.g. by boring or milling) is possible or any burr can be removed.

Advantageous developments of the invention result from the claims, the description and the drawings. The advantages of features and of combinations of a plurality of features mentioned at the beginning of the description only serve as examples and may be used alternatively or cumulatively without the necessity of embodiments according to the invention having to obtain these advantages. Without changing the scope of protection as defined by the enclosed claims, the following applies with respect to the disclosure of the original application and the patent: further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims.

The number of the features mentioned in the claims and in the description is to be understood to cover this exact number and a greater number than the mentioned number without having to explicitly use the adverb “at least”. For example, if a lining, an accommodation or a web is mentioned, this is to be understood such that
there is exactly one lining, exactly one accommodation or exactly one web,
there are two linings, two accommodations or two webs or
there are more linings, accommodations or webs.

Additional features may be added to these features, or these features may be the only features of the respective product.

The reference signs contained in the claims are not limiting the extent of the matter protected by the claims. Their sole function is to make the claims easier to understand.

### BRIEF DESCRIPTION OF THE DRAWINGS

In the following, the invention is further explained and described with respect to preferred exemplary embodiments illustrated in the drawings.

FIG. 1 shows a crimping tool locator with a lightening device in a very schematic view.

FIG. 2 in a three-dimensional view shows crimping pliers with a crimping tool locator supported by the crimping pliers for being pivoted about a pivoting axis where the pivoting axis has an orientation parallel to a longitudinal axis or a crimping stroke.

FIG. 3 in a three-dimensional view shows the crimping tool locator according to FIG. 2.

FIG. 4 in a three-dimensional exploded view shows the crimping tool locator according to FIGS. 2 and 3.

FIG. 5 in a three-dimensional view shows crimping pliers with a crimping tool locator supported by the crimping pliers for being pivoted about a pivot axis having an orientation parallel to a tool head plane.

FIGS. 6 and 7 in a three-dimensional exploded view show the crimping tool locator according to FIG. 5 from different viewing directions.

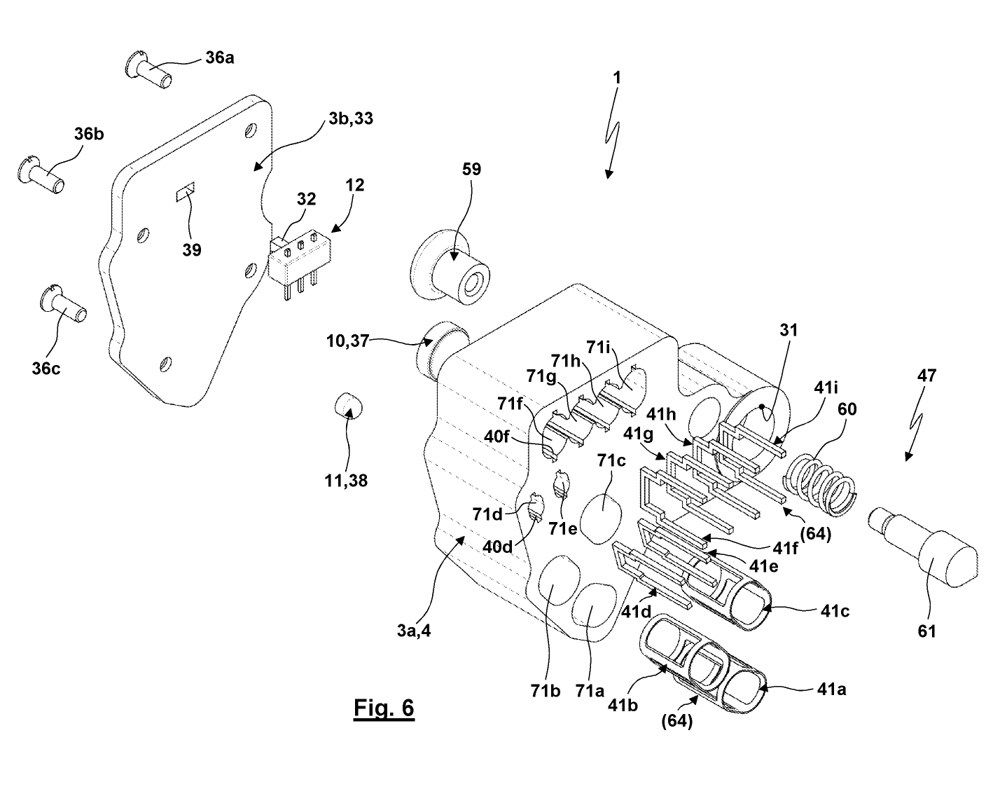

FIG. 8 in a three-dimensional view shows a component (here a base body) of the crimping tool locator according to FIGS. 5 to 7.

FIGS. 9 and 10 in three-dimensional views show linings for accommodations of crimping tool locators according to FIGS. 5 to 7 and for an accommodation of a base body according to FIG. 8.

FIG. 11 in a three-dimensional exploded view shows a crimping tool locator which is fixedly mounted to a tool head.

FIG. 12 in a three-dimensional view shows the crimping tool locator according to FIG. 11.

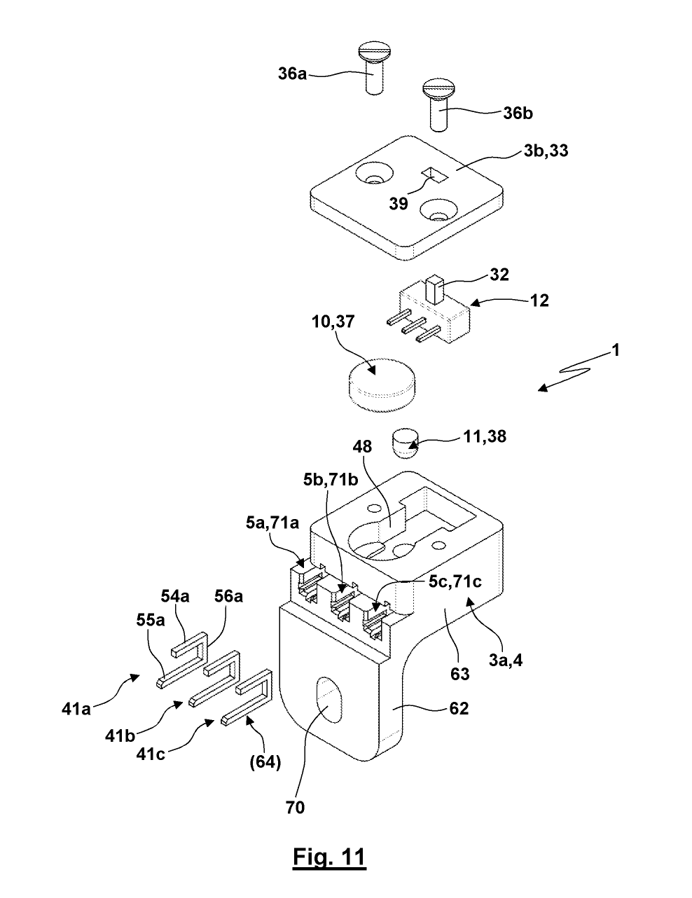

FIG. 13 shows a lining for an accommodation of a crimping tool locator according to FIGS. 11 and 12.

FIG. 14 schematically shows a method for manufacturing a crimping tool locator.

### DETAILED DESCRIPTION

In the Figs. partially the same reference numerals are used for components or features of different embodiments or a plurality of components or features in the same embodiments which have the same or a similar geometric design and/or function. In this case in one embodiment different components or features are distinguished by an additional letter a, b, . . . . Here, reference can also be made to all of these components or reference numerals by not using of the additional letter.

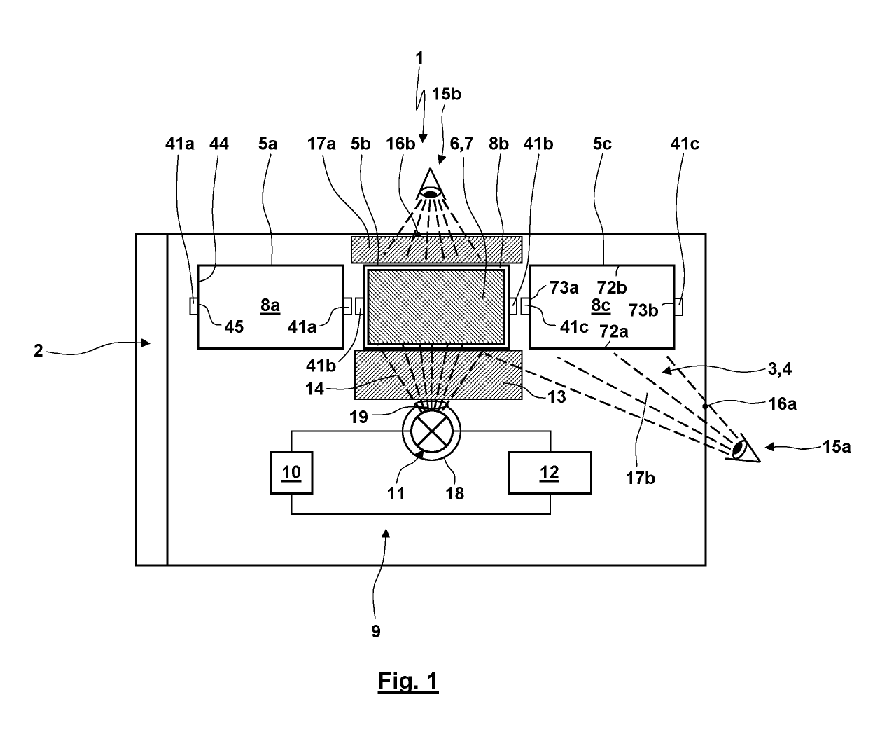

FIG. 1 very schematically shows a crimping tool locator 1. The crimping tool locator 1 comprises a connecting region 2. It is possible to connect the crimping tool locator 1 by the connecting region 2 to a crimping tool 20. If the crimping tool 20 is embodied as crimping pliers 21, the connecting region 2 might provide a rigid mounting of the crimping tool locator 1 to a tool head. It is also possible that the connecting region 2 provides that the crimping tool locator 1 is moveable relative to the tool head, in particular moveable into an insertion position in which it is possible to insert a workpiece as a plug into an accommodation 5 of the crimping tool locator 1, and moveable into an operating position in which the plug positioned in the crimping tool locator 1 is arranged such that the plug with the cable arranged therein can be crimped in the crimping region of the crimping pliers 21. Here, it is possible that the connecting region 2 provides a pivoting movement of the crimping tool locator 1 between the insertion position and the operating position about a pivoting axis 29. The pivoting axis 29 might e.g. have an orientation along the longitudinal axis of the tool head which preferably corresponds to a direction of a crimping stroke or along a transverse axis of the tool head or in a direction vertical to a tool head plane. However, it is also possible that the connecting region 2 provides a relative movement of the crimping tool locator 1 between the insertion position and the operating position. The crimping tool locator 1 comprises a component 3, in particular a base body 4. The base body 4 directly forms the connecting region 2 or is fixed to the same. Preferably the component 3 or the base body 4 is made of a transparent plastic material.

An accommodation 5 is formed in the component 3 or base body 4. For the embodiment according to FIG. 1 three accommodations 5a, 5b, 5c are arranged one besides the other. It is possible that the accommodations 5 have a cross section being closed in circumferential direction with a cross section which generally corresponds to the cross section of the workpiece 6, in particular a plug 7. For the shown embodiment the plug 7 is arranged in the middle accommodation 5b. The plug 7 is arranged in the respective accommodation 5b in a way such that an orientation of the longitudinal axis of the plug 7 corresponds to a longitudinal axis of the accommodation 5 and a position of the plug 7 in a direction transverse to the longitudinal axis of the accommodation 5 is defined within predefined tolerances.

The accommodations 5 comprise insertion openings 8a, 8b, 8c. It is possible to insert the plug 7 through the insertion openings 8a, 8b, 8c into the accommodations 5. The accommodations 5 might be through-accommodations of the component 3 or the base body 4 or might have a bottom which provides a limitation for the depth of the insertion of the plug 7 into the accommodation 5.

Furthermore, the crimping tool locator 1 comprises a lightening device 9. The lightening device 9 comprises an energy source 10, a lamp 11 and a switch 12. A material region 13 made of a transparent material of the component 3 or the base body 4 is arranged between the lamp 11 and at least one associated accommodation 5b. A cone of light 14 of the lamp 11 is able to illuminate the interior of the accommodation 5b (here the workpiece 6 or the plug 7) through the material region 13. In FIG. 1 different positions 15a, 15b are schematically shown. From the different positions 15a, 15b an eye of a user is able to inspect the accommodation 5 through an outer surface 16a, 16b through the material region 17a, 17b of the transparent material of the component 3 or the base body 4. The inspection might in some cases be supported by the illumination of the interior of the accommodation 5 by the lamp 11. In FIG. 1 schematically also a reflector 18 and a lens 19 are shown. By the reflector 18 and the lens 19 it is possible to focus the cone of light 14 of the lamp 11 to at least one accommodation 5. For the shown embodiment the cone of light 14 of the lamp 11 illuminates only an associated accommodation 5b. In this case further operated lamps 11a, 11c (operated in a parallel connection, a line connection or operated separately) can be provided. The further lamps 11a, 11c illuminate other accommodations 5a, 5c. However, it is also possible that one single lamp 11 illuminates a plurality of the accommodations 5 or all of the accommodations.

Optionally it is also possible that the accommodations 5 are not delimited or defined only by the transparent material 5 of the base body 4. Instead, the accommodations 5 are equipped with linings 41 of a harder and/or more wear resistant and in particular non-transparent material (e.g. a plastic material or metal). Here, the linings 41 form inner surfaces 45 by which the plug 7 is held and/or guided in the accommodations 5. Together with the transparent material of the base body 4 in a partial region 44 the inner surfaces 45 of the linings 41 delimit or define the accommodations 5. Here, the inner surfaces 45 and the transparent material of the base body 4 form a flush common inner surface for defining or delimiting the accommodation 5 or together form a contour which is suitable for accommodating and guiding the plug 7. The linings 41 are embedded into the transparent material of the base body 4. For an embodiment not shown here it is possible that the linings 41 made of the transparent material of the base body 4 protrude in the way of ribs or protrusions or contact bodies. In this case it might then also be possible that the plug 7 arranged in an accommodation 5 contacts the lining 41 whereas the plug 7 does not contact an adjacent partial region 44 of the transparent material. The circumference or the contour of the accommodations 5 is delimited by partial circumferential region 72a, 73a, 72b, 73b. Here, the limitation in the partial circumferential regions 72a, 72b is provided by the transparent material of the base body 4 whereas the limitation in the partial circumferential regions 73a, 73b is provided by the inner surfaces 45 of the linings 41.

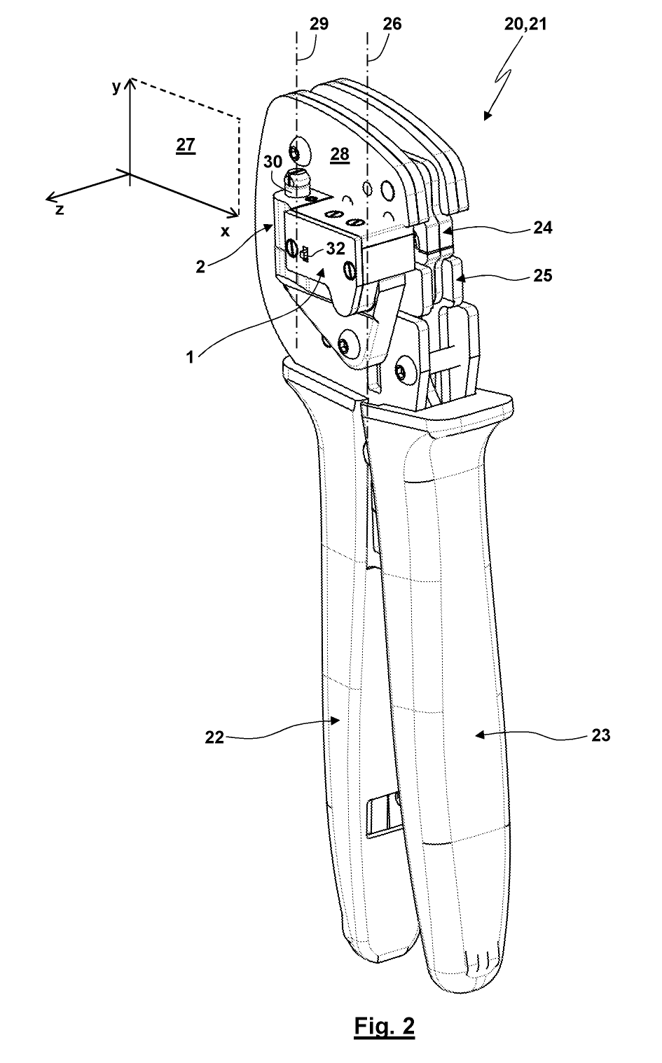

FIG. 2 shows in a three-dimensional view a crimping tool 20 which is here embodies as crimping pliers 21. Generally, crimping pliers 21 corresponding to FIG. 2 are distributed by the applicant under the label “CS30”. With respect to the design of crimping pliers 21 of this type reference is in particular made to the publications DE 197 13 580 C2 (corresponding to U.S. Pat. No. 5,913,933 A), DE 197 53 436 C2, DE 297 12 879 U1, DE 298 03 336 U1 and DE 20 2008 003 703 U1. These publications are incorporated by reference into the disclosure of the present patent application with respect to the design of the crimping pliers 21 and the general design of any crimping tool locator 1 held at the crimping pliers 21.

In the crimping pliers 21 the hand levers 22, 23 are actuated manually with a relative movement of the hand levers 22, 23 towards each other. By a drive mechanism the movement of the hand levers 22, 23 is coupled to a relative movement of the die halves 24, 25 between which a crimping region is formed wherein a workpiece (here a plug 7 with a cable arranged therein) is crimped. With the pivoting movement of the hand levers 22, 23 towards each other it is possible to induce a relative crimping stroke of the die halves 24, 25 along a longitudinal axis 26.

The crimping pliers 21 define a pliers head plane 27 which has an orientation parallel to the x-y-plane in FIG. 2 and wherein the die halves 24, 25 move over the crimping stroke. The crimping tool locator 21 is supported for being pivoted about a pivoting axis 29 at the tool head 28. For this purpose a pivoting bolt 30 which is arranged coaxially to the pivoting axis 29 is held by the tool head 28. The pivoting axis 29 has an orientation parallel to the longitudinal axis 26. The pivoting bolt 30 extends through a bearing bore 31 of the crimping tool locator 1. For the embodiment shown in FIG. 2 the crimping tool locator 1 comprises an actuation means 32 on the side facing away from the tool head 28 which is accessible from the outside for the user.

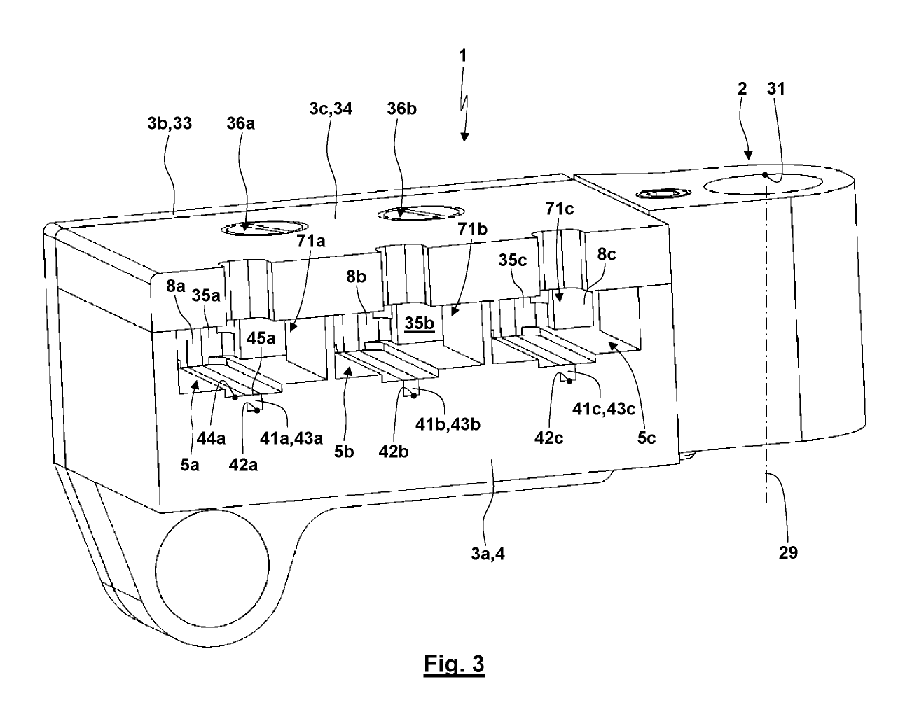

FIG. 3 shows the crimping tool locator 1 in a three-dimensional view. The crimping tool locator 1 comprises components 3a, 3b, 3c which are here formed by a base body 4 and covering plates 33, 34. The base body 4 and the covering plate 34 together delimit accommodations 5a, 5b, 5c. Here, the base body 4 forms recesses having a cross section with a closed edge. The recesses are closed by the covering plate 34 to an accommodation 5 having a closed edge. A bottom 35a, 35b, 35c of the recesses of the base body 4 delimits the recesses 5 on one side in longitudinal direction and forms a stop for the inserting movement of the plug 7.

The covering plate 34 and the base body 4 are screwed to each other by screws 36a, 36b. Here, the screws 36a, 36b can be screwed with the material of the base body 4, in particular with the plastic material. However, it is also possible that threaded sleeves are cast with or bonded to the material of the base body 4. In this case the screws 36a, 36b are screwed into the threaded sleeves.

On the side facing away from the tool head 28 the base body 4 forms a recess (which is not shown in FIGS. 2 to 4) for building an inner chamber 48. The inner chamber 48 is closed by screwing the covering plate 23 with the base body 4. In this inner chamber 48 the illuminating device 9 with the energy source 10, here a button cell battery 37, the switch 12 and the lamp 22, here a LED 38 with the associated cable connections can be housed. The covering plate 33 comprises a slit-like recess 39. The actuation means 32 of the switch 12 extends through the recess 39 to the outside so that it is possible to actuate the switch 12 from the outside.

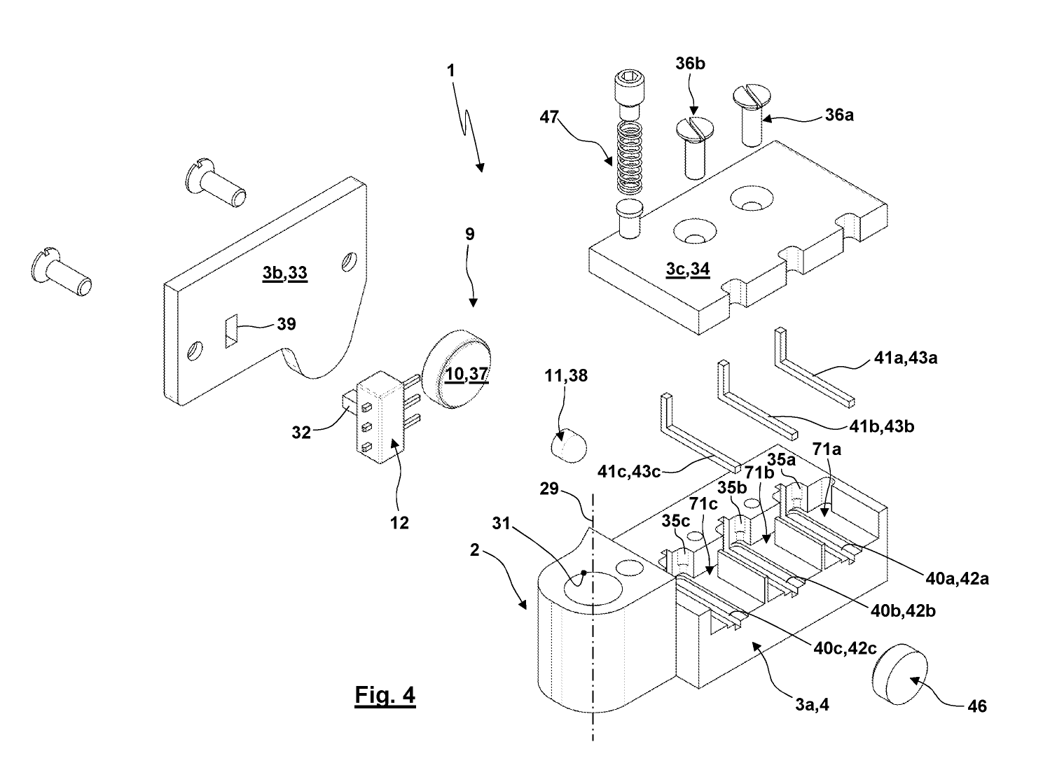

In particular in FIG. 4 it can be seen that in the region of the accommodations 5 the base body 4 comprises recesses 71. The inner contour of the recesses 71 generally corresponds to the geometry of a workpiece 6 which is to be positioned therein. The recess 71 again comprises a recess 40 wherein a lining 41 is arranged. For the shown embodiment the recesses 40 are embodied as L-shaped grooves 42 whereas the linings 41 are formed by L-shaped webs 43. The L-shaped grooves 42 extends with one leg of the L parallel to the longitudinal axis of the accommodations 5 and extend within the inner wall of the accommodations 5. Instead, the other leg of the L extends in the region of the bottom 35 of the accommodation 5. The dimensions and orientations of the webs 43 correspond to those of the grooves 42. In the delivery state of the crimping tool locator 1 the webs 43 are arranged in the grooves 42. A partial region 44 of the accommodation 5 adjacent to the groove 42 which is formed by the material of the base body 4 is arranged flush to the inner surface 45 of the web 43. Accordingly, in this region the accommodation 5 is delimited together by the partial region 44 of the base body 4 and the inner surface 45 of the web 43. The corresponding applies in the region of the bottom 55 where the accommodation 5 is also formed together by the flush surfaces on the one hand of the base body 4 and on the other hand of an inner surface of the angled leg of the L of the web 43. If a workpiece 6 as a plug 7 is slit into one of the accommodations 5, this is done under the guidance by the inner surface 45 of the web 43. If the material of the base body 4 is softer than that of the web 43, nevertheless a good guidance in the accommodation 5 is provided and in some cases there is also a reduced wear of the accommodation 5 also for a long-lasting use.

The base body 4, the covering plate 33 and/or the covering plate 43 is/are preferably made of a transparent plastic material. Instead, the linings 41 are made of a metallic material as steel or aluminium or a non-transparent plastic material. Preferably, the linings 41 have a higher hardness or wear resistance than a transparent or non-transparent plastic material used for the base body.

In a generally known fashion the crimping tool locator 1 can be secured in single pivoting positions (in particular in the insertion position and/or the operating position) by a permanent magnet 46 which cooperates with a counter magnet of the tool head 28 in the operating position and/or by a latching device 47.

Due to the fact that at least one of the components 3 is made of a transparent plastic material, the user of the crimping tool 20 is able to inspect the interior of the accommodations 5. Assistance is provided to the user by the illuminating device 9 which illuminates the plug 7 arranged in the accommodation 5 through the transparent material.

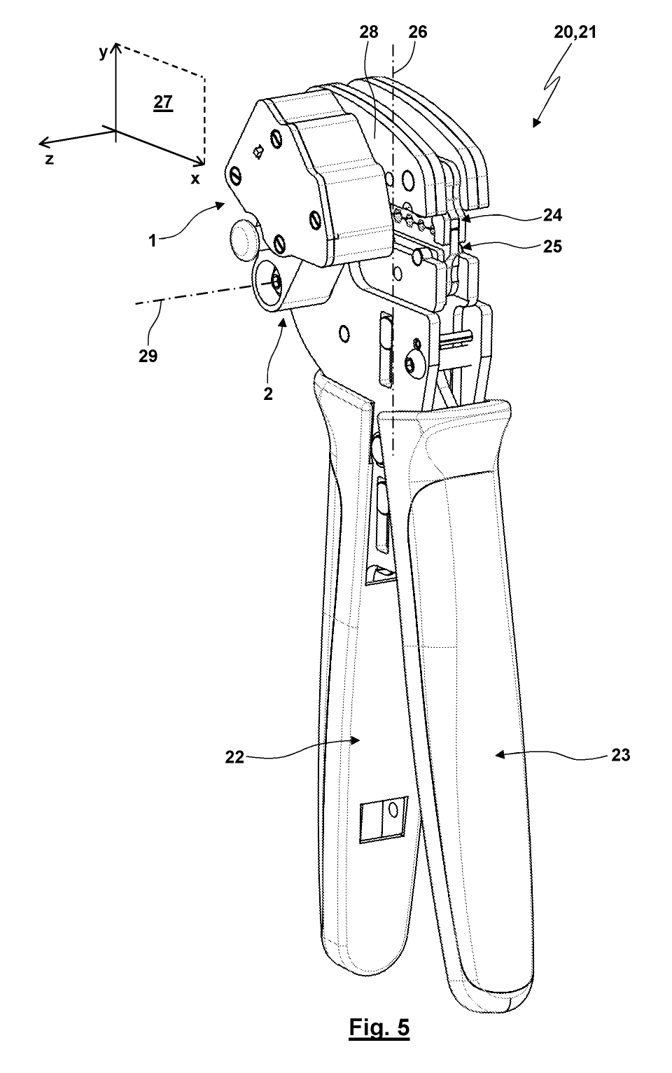

FIG. 5 shows crimping pliers 21 corresponding to the embodiment of FIG. 2. Here, a different crimping tool locator 1 is mounted to the crimping pliers 21. The crimping tool locator 1 is pivoted about a pivoting axis which has an orientation perpendicular to a tool head plane 27. Here, a housing of the crimping tool locator 1 is solely formed by two components 3a, 3b, namely the base body 4 and the covering plate 33.

FIG. 7 shows an inner chamber 48 which is located on the side facing away from the tool head 28 and which is open in outer direction. The lightening device 12 is accommodated in the inner chamber 48. The inner chamber 48 is closed by the covering plate 33.

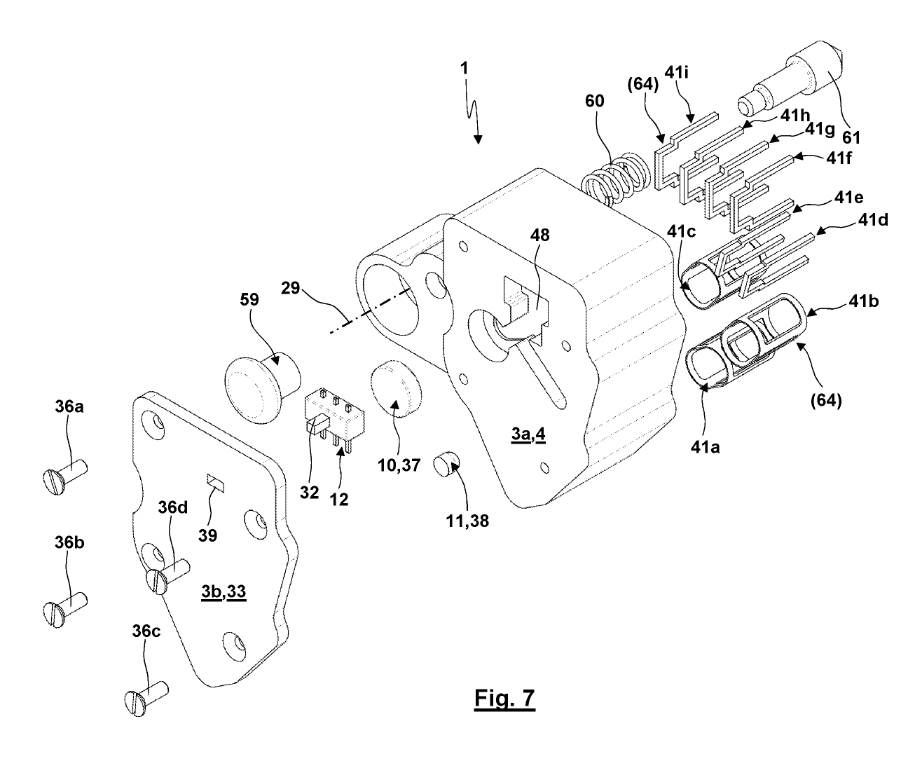

According to FIG. 8 the base body 4 comprises blind-hole-like recesses 71 on the side facing towards the tool head 28 for building the accommodations 5. Here, the recesses 71 of the base body 4 have a cross section with closed edge. Here, different sets of accommodations 5a to 5c, 5d to 5e as well as 5f to 5j with different geometries for different types of plugs are provided. Dependent on the pivoting position of the crimping tool locator 1 about the pivoting axis 29 the different sets of recesses 5 can be arranged behind dies of the die halves 24, 25 arranged one besides the other.

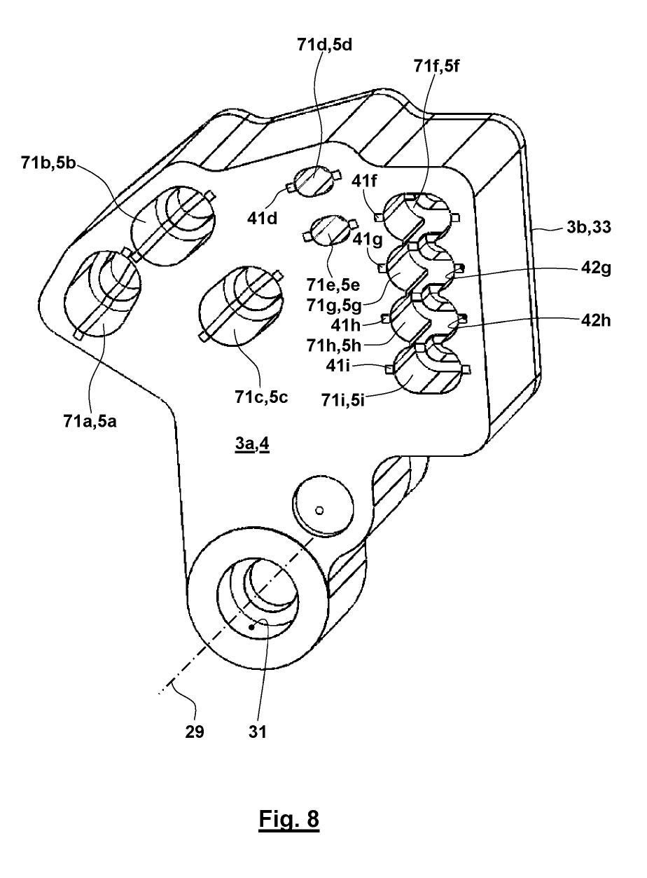

For the recesses 5a to 5c a lining 41a to 41c is used as shown in FIG. 9. Here, the linings 41a to 41c are sleeves 49. The sleeve 49 is open in both end regions and forms an open inner chamber into which the workpiece 6 can be introduced. For the shown embodiment the sleeve 49 comprises an oval cross section and has a constant wall thickness which is preferably smaller than 1.0 mm, 0.8 mm, 0.5 mm or even 0.3 mm. In the region of its circumferential surfaces the sleeve 49 comprises four recesses having a closed edge and building windows 50a to 50d. On its front side the sleeve 49 comprises two oval rings 51, 52. The oval rings 51, 52 are connected to each other by four webs 53a to 53d extending in longitudinal direction. Accordingly, the windows 50 are each limited in axial direction by the rings 51, 52 and in circumferential direction by adjacent webs 53. The lining 41 formed by the sleeve 49 is embedded into the material of the base body 4 in the region of the recesses 40 of the accommodations 5a to 5c.

FIG. 10 shows a lining 41 used for the accommodations 5d to 5j. The lining 41 is here U-shaped with parallel side legs 54, 55 and a base leg 56. Here, the side legs 54, 55 taper towards the base leg 56 which for the shown embodiment is provided by steps 57, 58. In this case the recesses 40d to 40j are grooves 42d to 42j wherein the lining 41d to 41j are accommodated. Here, the side legs 54, 55 extend parallel to the longitudinal axis of the accommodations 5d to 5j. Instead the base leg 56 is embedded into the bottom 35d to 35j of the accommodations 5d to 5j. Here, it is possible that the linings 41d, 41e for the accommodations 5d, 5e on the one hand and linings 41f to 41j for the accommodations 5d to 5j on the other hand have different geometries, in particular different lengths of the side legs 54, 55 and the base leg 56.

Also here the crimping tool locator 1 comprises a latching device 47. The latching device 47 comprises an actuation button 59, a latching spring 60 and a latching body 61. It is also possible (as can be seen for the recesses 71f to 71j in FIG. 8) that the recesses 71 and so also the accommodations 5 have a cross section with an open edge and that accordingly adjacent accommodations 5 transit into each other.

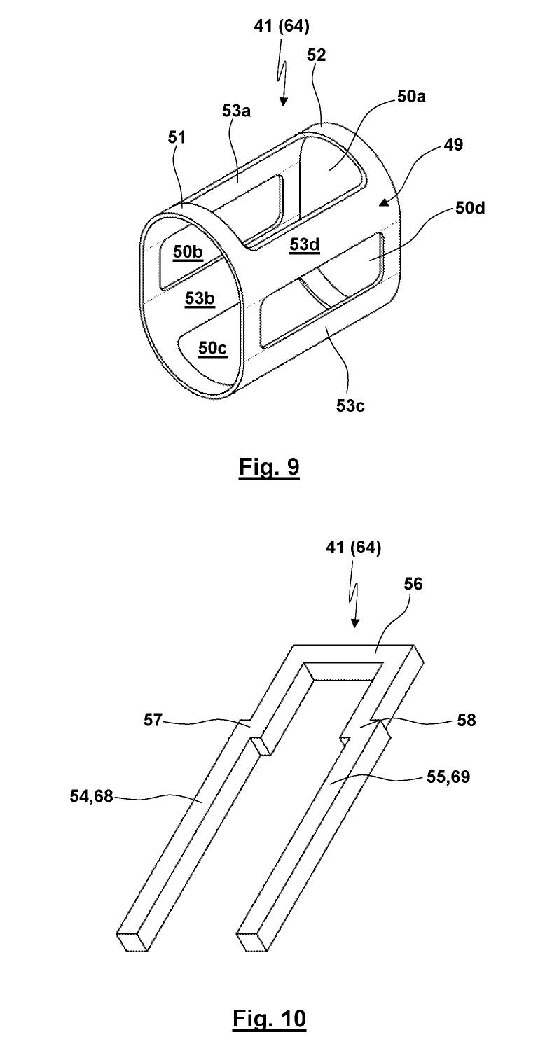

FIG. 11 shows another embodiment of a crimping tool locator 1. In this embodiment the base body 4 is angled to an L-shape with legs 62, 63. Here, the leg 62 comprises an elongated hole 70. With an orientation of the leg 62 parallel to the tool head plane 27 the base body 4 can be fixedly screwed to the tool head 28 by use of the elongated hole 70. Here, the elongated hole 70 provides the option of adapting the height. The accommodations 5a to 5c are here arranged in the transition region between the two legs 62, 63. In the region of the leg 63 which extends perpendicular to the tool head plane 27 the base body 4 forms the inner chamber 48. The inner chamber 48 is open in upper direction and (after arranging the illuminating device 9 in the inner chamber 48) closed by the covering plate 33 with the screws 36a, 36b. The recesses 71a to 71c of the accommodations 5a to 5c have an open edge in the entrance area, namely the recesses 71a to 71c are open in upper direction. Instead, the recesses 71a to 71c in the end region or in the second half have a closed edge, namely the recesses 71a to 71c are closed in upper direction by the material of the base body 4. The linings 41a to 41c and the associated grooves 42a to 42c of the recesses 71a to 71c are also U-shaped with side legs 54, 55 as well as a base leg 56. Due to the fact that the entrance area of the accommodations 5a to 5c is open in upper direction here the side legs 54, 55 have different extensions in longitudinal direction.

Preferably the illuminating device 9 is equipped with an energy source 10, in particular a battery or a button cell battery which does not require an exchange over the lifetime of the crimping tool locator 1 which is in particular more than 10 years. It is possible that a pre-fabricated illuminating circuit is inserted into the inner chamber 48 of the crimping tool locator 1. Here, it is also possible that a circuit of this type is cast to a block, in particular made of plastic, and the circuit is inserted as a block of this type into the inner chamber 48. It is possible that the block already comprises an outer geometry which is adapted to the geometry of the inner chamber 48 so that when inserting the block into the inner chamber 48 automatically the correct position and orientation of the block and so also of the lamp 11 is defined.

It is possible that the latching device 47 is also used for sliding relative to the pliers head 28 along an actuating slope during the relative movement of the crimping tool locator. In this way simultaneously to the movement of the crimping tool locator 1 a movement parallel to the pivoting axis 29 can be induced.

The covering plates 33, 34 and the base body 4 can be made of any materials with any properties. Preferably, at least one component of the covering plates 33, 34 and the base body 4 is made of a transparent plastic material. The linings 41 are manufactured from a harder or more wear resistant material than the transparent plastic material. This might also be a (transparent or non-transparent) plastic material or also e.g. a metallic material. For the type of provision of the linings 41 at the crimping tool locator 1 there are a lot of options. For a first variant the linings 41 are inserts 64. Accordingly, the linings 41 are manufactured and provided separately. The linings 41 are inserted into the recess 71 of the base body 4. The linings 41 enter into the recesses 40 or grooves 42. In a state inserted in this way into the recess 40 or groove 42 the linings 41 can be connected to the recesses 40 by a press fit, friction lock, by latching, by locking, by gluing or adhesively bonding or by an additional fixing means and secured here.

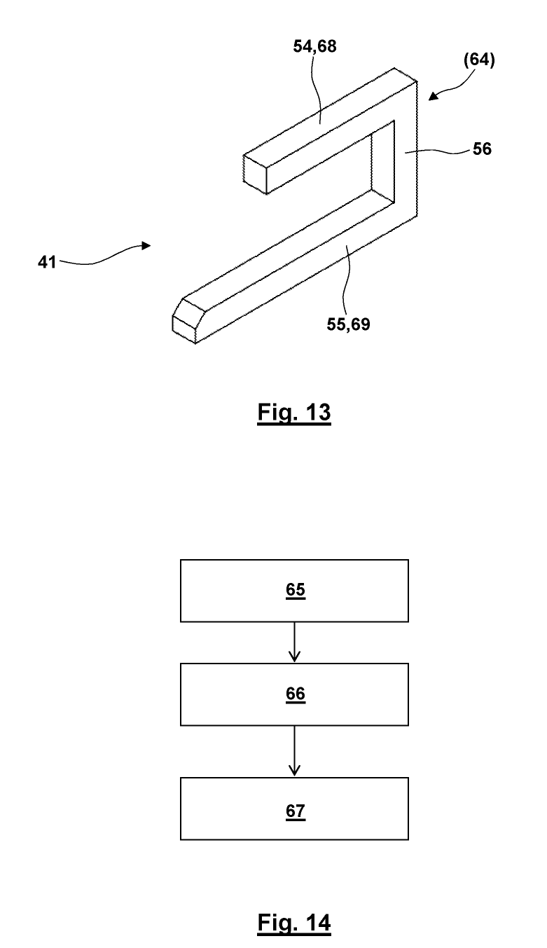

For another variant the linings 41 are provided in the crimping tool locator 1 by means of a method for manufacturing which is very schematically shown in FIG. 14. Here, the method for manufacturing is explained as an example for the production of a lining 41 of the base body 4. In a corresponding way it is possible that a lining 41 in at least one covering plate 33, 34 is produced. In a method step 65 a first material, in particular a transparent plastic material, is injected into a mould comprising a cavity corresponding to the outer contour of the base body 4. A definition of the contour of the recesses 40 as well as the recesses 71 can be provided by correspondent shaping of the mould or suitable inserts or cores. Here, the shapes of the form, the insert or the cores comprise ribs corresponding to the contour of the grooves 42. Accordingly, after the hardening of the first material the base body 4 comprises recesses 71 with the recesses 40 or grooves 42.

Subsequently, in a second method step 66 the intermediate product produced from the first material is inserted into a different mould or inserts or cores are removed from the mould and replaced by different inserts or cores. The different mould or the different inserts or cores have a form or geometry which corresponds to the cross section of the in the end produced accommodations 5 including the linings 41. Accordingly, the form or the inserts or cores do not have the ribs for forming the grooves 42. In the simplest case the inserts or cores used in the second method step 66 generally correspond to the inserts or cores which have been used in the first method step 65 with the exception that the inserts or cores used in the second method step 66 do not have ribs. Instead, the inserts or cores have an outer surface which is flush in the adjacent partial region 44 of the recess 71 or which transits in a way corresponding to the contour of the workpiece 6 to the adjacent partial region 44 of the recess 71. Between the intermediate product manufactured from the first material and the form of the mould, the outer surface of the insert or core a cavity remains. The geometry of the cavity corresponds to the geometry of the lining 41 which is to be produced. A second material, in particular a non-transparent plastic material or a metallic material, is then inserted into this cavity. After the hardening the second material forms the lining 41.

Optionally it is possible that in a subsequent method step 67 there is a post processing of the accommodations, in particular a milling or boring post processing.

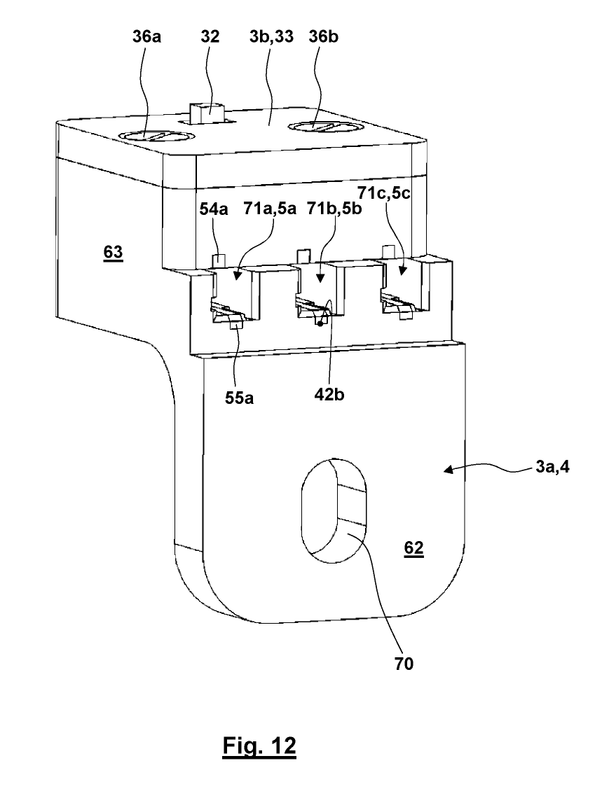

For the embodiment of the linings 41 according to FIGS. 10 and 13 the side legs 54, 55 each form webs 68, 69 which extend parallel to the longitudinal axis of the accommodations 5.

Also for the bracket-like or strut-like design of the linings according to FIG. 4, FIG. 10 and FIG. 13 remote from the material of the linings 41 windows 50 are established. In the region of the windows 50 the accommodation 5 is not limited by the lining 51 but by the material of the base body 4 so that by use of a transparent material an inspection into the interior of the accommodations 5 is possible. If the lining 41 is e.g. only formed by a web, the web only extends over a very small part of the circumference. Instead, the remaining part of the circumference is then formed by the transparent material so that in this part of the circumference the window 50 is formed.

Generally, an inventive crimping tool locator might also be used (differing from the shown embodiment) for any crimping tool or crimping pliers and for any other design of the crimping tool locator. For this purpose in the following only some examples will be mentioned. However, options of the use of the inventive design should not be limited to these examples:
Possible is a use of an inventive crimping tool locator for crimping tools as being distributed by the applicant under the labels CS10, CSV10, CSV10-LBL, CS11, CS30 or in connection with electrical crimping tools CS150 or as embodied as table crimping devices CS200, pneumatical processing systems CP600 or pneumatical crimping machines UP60. Also crimping tool locators used here can be adapted in the inventive way.
It is also possible to use the invention for crimping pliers or crimping tool locators as described in the publication DE 198 32 884 C1 (corresponding to U.S. Pat. No. 6,155,095 A). Here, it is possible to pivot the crimping tool locator about a pivoting axis running through the tool head plane 27 and having an orientation transverse to the longitudinal axis and to the crimping stroke.
An alternative embodiment of crimping pliers as well as of a pivotable locator which can be pivoted about a transverse axis and for which also the inventive measures might apply, is known from DE 10 2008 017 366 A1 (corresponding to U.S. Pat. No. 8,161,789 B2).
Another embodiment of crimping pliers as well as of a crimping tool locator is known from DE 20 2008 003 703 U1. Here, the crimping tool locator might additionally comprise a securing element held with a pivoting degree of freedom at the base body 4. By the securing element it is possible on the one hand to additionally secure a workpiece as a plug in the accommodation and on the other hand to form a stop which defines how deep a cable can be slid into the accommodation and/or the plug. A securing element of this type might also be embodied as a cable stop element or so called “wire stop”.
It is also possible to transfer the invention to a crimping tool locator according to DE 10 2010 061 148 A1. The crimping tool locator can be adjusted such that it is possible to arrange an accommodation of the crimping tool locator alternatively behind different dies of the crimping pliers. Here, the publication discloses a crimping tool locator wherein the accommodations can be displaced transverse to the crimping direction in the pliers head plane or wherein the crimping tool locator can be rotated similar to a revolver about an axis having an orientation perpendicular to the tool head plane 27.
Another embodiment of crimping pliers comprising a crimping tool locator upon which the inventive measures can be applied is disclosed in publication EP 2 672 580 A1.

Within the frame of the invention a “high hardness” is in particular interpreted as a higher hardness corresponding to at least one of the common measuring methods for determining the hardness. This might e.g. be a hardness of
a universal hardness according to DIN EN ISO 14577,
a Rockwell hardness (HR) according to DIN EN ISO 6508-1, cp. also “Lexikon Kunststoffprüfung and Diagnostik” (W. Grellmann, C. Bierögel, K. Reincke) or http://wiki. polymerservice-merseburg.de/index.php/Rockwell-Härte (date of inspection 21.10.2016),
a hardness Brinell according to DIN EN ISO 6506-1 to EN ISO 6506-4,
a hardness according to the hardness analysis with a Poldi hammer,
a hardness Vickers (HV) according to DIN EN ISO 6507-1: 2005-4 2005,
a hardness according to Knoop according to DIN EN ISO 4545-1-4,
a Shore-hardness according to the standard DIN EN ISO 868 and DIN ISO 7619-1, in particular a hardness Shore A, Shore B, Shore C or Shore D, cp. also http://wiki. polymerservice-merseburg.de/index.php/Shore-Härte (date of inspection 21.10.2016),
a hardness Barcol according to standard DIN EN 59.

Preferably a hardness of the lining 41 according to the aforementioned definitions is at least 20%, 50% or even 100% higher than the hardness of the component 3 made of the transparent or non-transparent plastic material. The lining 41 might here consist of metal or a plastic material. For one example the lining 41 is manufactured from polyamide. Preferably, the lining 41 comprises a hardness Shore A being higher than 100 N/mm², higher than 120 N/mm², higher than 140 N/mm², higher than 150 N/mm² or even higher than 170 N/mm². It is also possible that the lining 41 has a ball indentation hardness being higher than 100 N/mm², higher than 120 N/mm², higher than 140 N/mm², higher than 150 N/mm² or even higher than 170 N/mm². In order to mention only some non-limiting examples for further possible materials for the lining 41, it is mentioned that here a PVC-C plastic material, a PMMA-XT plastic material, a PMMA-GS plastic material, a PC plastic material, a SAN plastic material, a PA 6 plastic material, a PA 6.6 plastic material, a POM plastic material, a PET plastic material, a PVDF plastic material, a PEEK plastic material, a PES plastic material, a PSU plastic material, a PEI plastic material, in particular with a hardness of at least 100 N/mm² (Shore A or ball indentation hardness) can be used.

A wear resistance can be determined on the basis of the standard DIN 50320. Within the frame of the invention it is possible that the lining 41 comprises a hardened and/or coated surface for increasing the wear resistance. It is also possible that the increased wear resistance is provided by a higher stiffness or tensile strength or a higher module of elasticity of the material.

A transparent material of the base body 4 and/or of a covering plate 33, 34 (preferably the material by which the accommodation 5 is delimited in the partial region 44) is e.g. a material on the basis of a polycarbonate (also abbreviated as PC) as these are in particular distributed under the registered trademarks “Makrolan” or the registered trademark “Lexan” or as specified on the internet-site http://www.kern.de/cgi-bin/riweta.cgi?nr=2301&Ing=1 (date of inspection 21.10. 2016) with the material number 2301, an acryl glass material or an acryl material, a Plexiglas material (registered trademark), a PMMA material or a SAN material (styrol-acrylnitril).

It is also possible that the base body 4 is manufactured from a non-transparent material whereas the lining 41 (in particular a web of a lining 41) is manufactured from a transparent material. The transparent material region of the lining 41 can then be used for transferring light from the lightening device similar to a “light channel” or optical wave guide to the position of interest, in particular in the accommodation 5 and/or to the crimping region. For this purpose preferably the light is introduced in an end region of the transparent material region, transferred through the transparent material region and the light exits then in the other end region which is preferably facing towards the accommodation 5 or the crimping region from the transparent material region. For this proposal it is also possible that the material of the lining 41 has a smaller hardness than the material of the base body 4 in the partial region 44.

Within the frame of the invention under the feature “lining” in particular a material region is subsumed which is embedded into the component 3 or the base body 4 which can be the case by material bonding or by an insert 64. In this embedded state the lining 41 is surrounded by the material of the component 3 or the base body with the exception of the inner surface 45 by which the lining 41 limits the accommodation, by which the lining 41 cooperates with the workpiece or plug and/or by which the lining 41 protrudes into the accommodation 5.

Many variations and modifications may be made to the preferred embodiments of the invention without departing substantially from the spirit and principles of the invention. All such modifications and variations are intended to be included herein within the scope of the present invention, as defined by the following claims.

We claim:

1. A crimping tool locator comprising an accommodation for a workpiece, the accommodation being delimited at least in a first part of a circumference by a component and in a second part of the circumference by a lining of the component, a material of the lining having a first hardness and a material of the component having a second hardness, the first and the second hardnesses differing from each other.

2. The crimping tool locator of claim 1, wherein
a) the component is made of a transparent material so that the component is transparent,
b) the component delimits both the accommodation for the workpiece as well as an outer surface of the crimping tool locator and
c) the transparent material of the component extends between the delimitation of the accommodation for the workpiece by the first part of the circumference and the outer surface of the crimping tool locator so that an inspection of an interior of the accommodation for the workpiece from the outside by looking through the outer surface of the crimping tool locator, through the transparent material of the component and through the first part of the circumference is possible.

3. The crimping tool locator of claim 2, wherein
a) the lining delimits a window and
b) the window and the lining are designed and arranged such that it is possible to inspect the interior of the accommodation through the outer surface of the crimping tool locator, through the transparent component and through the window delimited by the window.

4. The crimping tool locator of claim 3, wherein the lining is a sleeve comprising the window which is located at a circumference of the sleeve.

5. The crimping tool locator of claim 3, wherein that the lining comprises a web, the web extending in longitudinal direction of the accommodation, the window being formed adjacent to the web when seen in circumferential direction of the accommodation and the window being delimited by the web.

6. The crimping tool locator of claim 4, wherein the sleeve forms a web, the web extending in longitudinal direction of the accommodation, the window being formed adjacent to the web when seen in circumferential direction of the accommodation and the window being delimited by the web.

7. The crimping tool locator of claim 5, wherein in a first approximation the lining is U-shaped with a base leg and two side legs, the side legs of the U extending as webs on opposing sides of the accommodation when seen in circumferential direction and the side legs extending in longitudinal direction of the accommodation and the base leg of the U being arranged at a bottom of the accommodation.

8. The crimping tool locator of claim 1, wherein a lightening device is provided.

9. The crimping tool locator of claim 3, wherein a lightening device is provided.

10. The crimping tool locator of claim 9, wherein the lightening device illuminates an interior of the accommodation through the window.

11. The crimping tool locator of claim 9, wherein a lamp of the lightening device is covered in the direction of the accommodation by the component.

12. The crimping tool locator of claim 9, wherein the lightening device comprises at least one of a lens and a reflector.

13. The crimping tool locator of claim 1, characterized by at least one covering plate.

14. The crimping tool locator of claim 9, wherein a cone of light of the lightening device is adjustable.

15. The crimping tool locator of claim 1, wherein the lining is an insert inserted into a groove or a recess of the component.

16. The crimping tool locator of claim 2, wherein
a) the lining is adhesively bonded to the component,
b) the lining is cast or injection moulded to the component or
c) the component is injection moulded to the lining.

17. The crimping tool locator of claim 15, wherein the insert is adhesively bonded to the component.

18. The crimping tool locator of claim 8, wherein the lining is made of a transparent material and the lining serves as a light wave guide which extends between a lamp of the lightening device and the accommodation and which transfers light from the lamp of the lightening device towards the accommodation.

19. A tool head comprising a crimping tool locator of claim 1.

20. A crimping tool comprising a crimping tool locator of claim 1.
